(19) United States
(12) Patent Application Publication
(10) Pub. No.: US 2003/0149884 A1
(43) Pub. Date: Aug. 7, 2003

(54) Electronic information content control

(76) Inventors: Randolph Hernandez, Brooklyn, NY (US); Minh Huu Nguyen, Brooklyn, NY (US); Christopher Jules Scott James, Brooklyn, NY (US); Adam Elia Kidron, Montclair, NJ (US)

Correspondence Address: BROWN, RAYSMAN, MILLSTEIN, FELDER & STEINER LLP, 900 THIRD AVENUE, NEW YORK, NY, 10022, US

(21) Appl. No.: 10/062,277

(22) Filed: Feb. 1, 2002

(51) Int. Cl. G06F 17/60

(52) U.S. Cl. 713/193

(57) ABSTRACT

Systems and methods for the creation, modification, maintenance, and controlled distribution and presentation of electronic information. The invention provides content editors, control managers, content players, and data structures for protecting and accessing electronic data content. Protected data structures comprise presentation, identification, and control content, including unique file identifiers and optionally conditions specified by file owners for user access. Control managers authorize selected users/players to access protected filed structures. The invention also provides methods of distributing and marketing protected data structures.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, an insofar as those files or records made part of the public record, but otherwise reserves all copyrights whatsoever.

### BACKGROUND OF THE INVENTION

The invention disclosed herein relates to the creation and use of electronic information. In particular, the invention relates to the creation, modification, maintenance, and controlled distribution and presentation of protected electronic content.

Current methods for the creation, modification, maintenance, and controlled distribution or dissemination of electronic information content are complex, cumbersome, and inefficient, and often ineffective. This problem is particularly apparent in networked electronic information content distribution environments such as the World Wide Web and corporate Intranets.

For example, in such environments a website is often the vehicle for the distribution and presentation of electronic information content. Due to programming and architectural constraints associated with website design, operation, and maintenance, website content frequently is difficult and expensive to manage. Content must generally be updated on a regular basis, which requires substantial investments, including for example the hiring of programmers and system administrators in addition to content creators and designers. Content producers are thus often required to employ, train, and house substantial dedicated technological staffs to design, develop, implement, and maintain their websites. The overhead associated with these expenses results can greatly diminish the producer's return on investment.

Additional problems arise in the attribution of electronic content to its rightful sources. Web pages are notoriously susceptible to copying and other forms of infringement and/or plagiarism. Copy and paste techniques, for example, are typically simple to implement and are not easily traceable. Legal recourse may be available, but is often expensive and uncertain. Moreover, such plagiarism is so easy and widespread as to make enforcement in many cases a practical impossibility.

Web sites and similar content presentation systems are also susceptible to deep linking tactics, wherein a first site is linked to content located in at second site in such a manner that the identity of the second site as creator or originator of the content is obscured or altogether lost.

Yet another problem associated with current content distribution measures is that data structures used in the presentation and operation of web pages are large, and therefore difficult and cumbersome to transfer and store. This results, for example, in difficulties in collecting and aggregating content. It would be beneficial to reduce the size and increase the manageability of content units, for example by breaking content into smaller discrete packages. Such organization is highly desirable, for example, because it facilitates organization of content according to subject, creator, and other similar characteristics.

There is need for improved methods and systems for the creation, modification, maintenance, and controlled distribution and presentation of electronic information.

### BRIEF SUMMARY OF THE INVENTION

The present invention addresses the problems set forth above, and provides additional improvements as set forth herein. The invention provides systems and methods for the creation, modification, maintenance, and controlled distribution and presentation of electronic information. Systems and methods according to the invention enable creation and modification of protected electronic data structures, and the controlled distribution and presentation, e.g. “syndication,” of such structures; and provide tools for monitoring the use and distribution of protected content. Systems and methods according to the invention help to ensure proper attribution of the creation and ownership of protected data structures, and to prevent copying and other misuse of protected content. They further facilitate tracking or “version control” of modified or republished electronic content.

In one aspect the invention provides a content editor for a system for creating, modifying, and storing protected electronic content. Preferred content editors are adapted to create data structures such as computer files comprising embedded identification and control content as well as presentation content. The content of such data structures may be static, as in the case of still or animated graphic or text messages; or dynamic, such as interactive structures adapted for both presentation and acceptance of information, such as an interactive user poll presented by a graphical user interface (GUI). Identification content provided by content editors according to this aspect of the invention may include unique identification codes or other embedded means of associating such data structures with unique identifiers. Control content may comprise a wide range of content adapted for controlling access to the data structures, or for tracking or monitoring the use of such structures. For example, control content may comprise counters specifying a selected number of times the content of the data structure may be accessed by a given uniquely-identified user, such as a content player, or by any number of authorized users; or it may comprise content for enabling the polling of authorized users for such information as user satisfaction or criticism of the data structure, its contents, or associated systems; or it may comprise authorization structures adapted to authorize user access only upon satisfaction of conditions specified by the content owner. For example, access may be conditioned upon acceptance of commercial terms including payment terms, license agreements, or requests for consumer or other user information.

Preferably content editors according to this aspect of the invention are adapted to enable the modification of existing data structures. Modifications can include revisions to presentation content, for example the updating or replacement of graphics, animation, or textual content; to identification content, for example the addition, deletion, or modification of identification or access codes; and/or to control content. Importation of data structures created outside the system and conversion to protected data structures according to the invention is also optionally enabled.

In another aspect the invention provides a control manager for controlling and monitoring access and use of protected data structures. The control manager may reside on a server attached to and over a network such as the Internet. Control managers according to this aspect verify that users such as content players are authorized to access protected data structures, and optionally monitor use and access of data structures. For example, when an operator or user of a content player requests access to a protected data structure, the player locates the data structure, reads and/or decodes identification content embedded within or otherwise associated with the data structure, and queries the control manager for authorization. The control manager reads and/or decodes identification content associated with the data structure and identification content associated with the player, consults a table or other listing of authorizations, and authorizes or denies access. Optionally the control manager further accesses, prior to granting authorization for access to the data structure, control content associated with the data structure, and confirms that any conditions specified by such control content to access by the user have been satisfied. For example, the user may be required to provide consumer or other commercial or demographic information, or to indicate acceptance of sales or licensing terms, as a condition of access; or a maximum number of access events by one or more individual users may not be exceeded.

Authorization may comprise retrieving requested data structure(s) and/or providing to the user address for the data structures; or otherwise enabling player access to presentation content associated with the data structure.

Preferably control managers according to the invention comprise or are otherwise associated with memories accessible to the control managers for storing authorization data indicating whether content players according to the invention are authorized to decode or otherwise access protected data structures. Such memories may comprise, for example, one or more databases with fields or other data strings corresponding to properties associated with players and data structures.

Optionally editors and control managers according to these aspects of the invention are part of the same system, for example, part of a single program or programming structure (for example, separate objects within a single program structure), or are otherwise associated. For example, editors and controllers according to the invention may reside on separate computers, under control of separate operating systems, but be operated or controlled by a single network service provider. Optionally, in embodiments of the invention in which control managers and content editors are commonly operated or controlled, the control manager(s) control access to the content editors by users desiring to access the content editors (“content producers”). According to one embodiment of the invention, content editors reside on a server attached to a network such as the Internet.

In another aspect the invention provides a content player for accessing and presenting information contained within protected data structures according to the invention. Preferably content players according to the invention are accessed and operated by users (“content accessors”), who request access to information content contained within or otherwise associated with one or more protected data structures. Upon receiving such requests the content players access identification content associated with the data structure(s) and forward user request(s) to the control manager. Upon authorization by the control manager the content player accesses the protected data structure(s), either directly or through the control manager. Preferred content players display presentation content of accessed data structures in a graphical user interface (GUI) on a user computer system. For example, preferred content players display presentation content in a Windows GUI format, such as Windows 2000 Professional, the presentation windows controllable by conventional Windows GUI functions such as snap to grid, click and drag layout and sizing, save positioning, closing, and minimizing functions and presented in a virtual desktop. Optionally the content player provides a separate control window, presenting GUI icons for loading, starting, and stopping presentations in the various display windows.

Preferred content players according to the invention preferably reside either on the accessing user's own computer system or are accessed by the accessing user on a remote server via a computer network such as the Internet.

Preferably a single content player enables simultaneous or contemporaneous presentation of multiple data structures, or multiple instances of individual data structures or portions thereof.

Optionally content players according to the invention present control content associated with requested data structures prior to displaying presentation content. For example, a content player may be granted conditional access authorization by a control manager, and thereupon present to the user control content associated with the requested data structure, such as terms and acceptance options for commercial or licensing proposals, or responses to consumer or demographic polls. Upon compliance with the access conditions, as for example by forwarding response data entered by the user, the player is authorized or otherwise enabled by the control manager to display presentation content.

Optionally a user of a content player is required to satisfy access requirements to the player, as for example by logging on to a content player system through the use of user names and/or passwords.

Although in some embodiments content players according to the invention reside on an accessing user's computer, optionally one or more such content players are part of the same system as control manager(s) and/or content editors according to the invention, for example, part of a single program or programming structure (for example, separate objects within a single program structure), or are otherwise associated therewith, and accessed by the accessing user via a computer network such as the Internet. For example, editors, controllers, and players according to the invention may reside on separate computers, under control of separate operating systems, but be operated or controlled by a single network service provider.

In another aspect the invention provides protected data structures for controlled distribution and presentation, e.g. “syndication,” of electronic information. Such data structures comprise presentation content, such as images, text, or animation sequences, and identification content. Identification content comprises, for example, unique identification codes embedded within or otherwise associated with the data structure. Optionally data structures according to this aspect of the invention further comprise control content containing information required for conditional access to the presentation content, as described herein. Data structures according to the invention may comprise separate data files or other collections or machine readable information, or associated groupings of such files or information. In general, any machine readable encoding of data suitable for the purposes herein described will serve. Such structures may reside on permanent or volatile data storage devices, such as computer disks, tape drives, or CD-ROM memories.

In another aspect the invention provides group storage facilities for protected data structures. Such groupings may be provided, for example, in the form of data bases, data banks, or other data libraries. Preferably such groupings are organized such that content is searchable or otherwise reviewable by prospective accessors. For example, a databank of such structures can include groupings for news, weather, games, movies, etc. In preferred embodiments, a databank of such structures may reside on one or more servers, connected to content players, control managers, and content editors via a network such as the Internet.

Optionally databanks according to this aspect of the invention are part of the same system as control managers, content editors, and or content players according to the invention, for example, part of a single program or programming structure (for example, separate objects within a single program structure). For example, editors, controllers, players, and databanks according to the invention may reside on separate computers, under control of separate operating systems, but be operated or controlled by a single network service provider.

The invention further comprises systems and methods, including business models, for creating, modifying, maintaining, and controlling distribution and presentation of electronic information as herein described.

Content editors, control managers, and content players according to the invention may comprise software, firmware, hardware, or any combination(s) of software, firmware, and/or hardware suitable for the purposes described herein. Data structures according to the invention may comprise computer files, variables, programming arrays, programming structures, and/or any electronic information storage schemes or methods, or any combinations thereof, suitable for the purposes described herein.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a schematic functional diagram of a system for creating, modifying, maintaining, and controlling distribution and presentation of electronic information according to the invention.

FIG. 2 is a flow diagram presenting a method for a user to select whether to publish or purchase protected electronic information according to the invention.

FIG. 3 is a flow diagram presenting a method for a user to purchase protected electronic information according to the invention.

FIG. 4 is a flow diagram presenting a method for a user to publish protected electronic information according to the invention.

FIGS. 5 and 6 depict user interface screens for a content player according to the invention.

FIGS. 7 and 8 depict programming logic for creating and modifying protected data structures according to the invention.

FIG. 9 is a flow diagram presenting a method to present protected electronic information to a user according to the invention.

### DETAILED DESCRIPTION OF THE PREFERRED EMBODIMENTS

Preferred embodiments of methods, systems, and apparatus according to the invention are described through reference to the Figures.

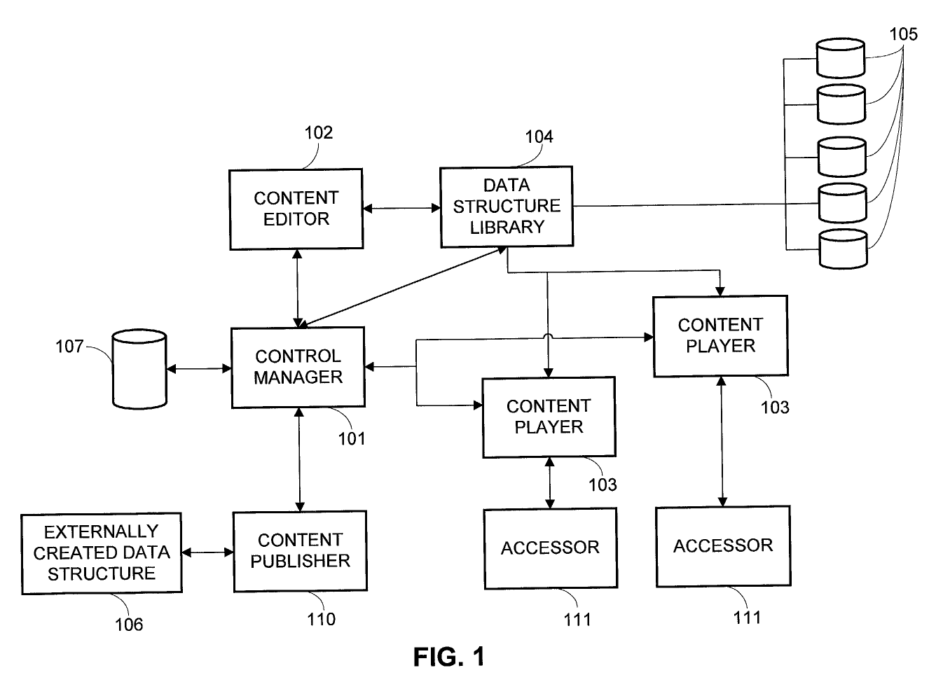

FIG. 1 is a schematic functional diagram of a system for creating, modifying, maintaining, and controlling distribution and presentation of electronic information according to the invention. System 100 comprises control manager 101, one or more content editors 102, one or more content players 103, and data library 104. Control manager 101, content editor(s) 102, content player(s) 103, and data library 104 may be under joint or separate control, in any suitable combinations. It is important to note that any and all of the components of the given items shown in FIG. 1 may be directly “hardwired”, or connected via a network such as a LAN, a wireless network, an intranet, the Internet, or any combination thereof.

Control manager 101 controls and monitors access to and use of protected data structures resident on storage devices 105 associated with data library 104, and content editor 102.

A content producer 110, such as for example an Internet advertising firm or an individual wishing to post information on the World Wide Web, who wishes to create a protected data structure requests authorization from control manager 101 to access content editor 102. For example, the content producer logs on to a web site operated by an operator of control manager 101 over a computer network such as the Internet, using a user name and password assigned by the operator. Control manager 101 verifies content producer 110's authority to access the content editor and enables the content producer to access the content editor. Content editor 102 then provides content producer 110 with a user interface suitable for creating a new protected data structure, modifying an existing data structure, or optionally for modifying externally-created data structure 106. Content producer 110 provides the content editor with presentation content and optionally any desired control content, such as any commercial conditions or maximum number of accesses, or information to be solicited by poll from a content accessor 111 by content player 103 upon accessing of the content by the accessor, to be associated with the protected data structure, or creates such presentation content with the aid of the editor. Optionally presentation content provided by content producer 110 comprises author or source information as well as still or animated graphic and/or textual information.

When content producer 110 is finished with entry of presentation and control content for the data structure, content editor 102 and/or control manager 101 provide identification content to be embedded within or otherwise associated with the data structure. Identification information for the data structure is stored in control data base 107 for later use by control manager 101 in authorizing and/or monitoring access to the data structure, and the data structure is indexed and stored within one or more data bases 105 by data structure library 104.

A user-accessor 111 wishing to access one or more protected data structures stored in data bases 105 accesses a content player 103, for example by accessing a web site controlled by or otherwise associated with control manager 101 and/or data library 104 via a computer network such as the Internet, or by starting a program resident on the accessor's own local computer. Optionally accessor 111 is required to provide a user name and/or password to gain access to content player 103. Accessor 111 provides the content player with a request for one or more specific data structures available through data library 104. Optionally, accessor 111 is enabled to review and/or search a listing of available data structures, as for example by browsing a web site available through the operator of library 104. Upon command of accessor 111, content player 103 requests authorization from control manager 101 to access the requested data structure(s). Control manager 101 checks the authority of accessor 111 and/or content player 103 to access the requested data structure(s) by comparing identification information supplied by the accessor and or content player with authorization data stored in memory 107 or contained in the data structure itself, including for example identification information associated by the system with the requested data structure(s). Depending upon the results of this comparison content player 103 is authorized to access the data structure is granted conditional access, subject to satisfaction by accessor 111 and/or player 103 with one or more conditions specified, or is denied access.

If user 111 and content player 103 are given conditional authority to access the requested data structure(s), player 103 reads control data associated with the data structure and queries accessor 111 for compliance action. For example, accessor 111 may be required to accept a license or purchase agreement, a pay per view arrangement, or to provide consumer or demographic data as a condition of accessing the presentation content.

Authorization may also be predicated on compliance with controls set by the content producer, such as maximum numbers of accessings by a specific accessor and or content player, or a maximum number of accessings by any accessors or content players. For example, a single user may be authorized to view an animated display a finite number of times, with a counter associated with the data structure and the accessor being incremented with each accessing; or a single data structure may carry authorization for a given number of viewings by any group of users. For example, an animated display may be authorized for a maximum of 100,000 showings, regardless of who accesses it or how many times it is accessed. Authorization may also be predicated on compliance with controls set by the content producer relating to limited distribution of a data structure according to player and/or user identity. For example, an animated display may be a “collectable” limited release to a given group of specific players which could include a given number of specific players selected at random, specific players which were within a given number of those players to first request access to the animated display, or any other specific player selection criteria sufficient to create a group of specifically identified players able to decode the animated display.

If user 111 and content player 103 are authorized to access the data structure, the player is enabled to access or download the structure or a copy thereof, and to display the presentation content.

Denial of access to the data structure can be used as a condition to render a data structure unusable. For example, an unauthorized attempt to access a data structure can cause the structure to be deleted, in whole or part, or cause all or some portion of the content to be corrupted so that it is unreadable by one or more players 103.

Optionally control manager 101 also monitors use of the data record(s) accessed by accessor 111 and/or content player 103. For example, the number of times a given record has been accessed may be counted, the revenue generated by users accessing a given record, or identification information associated with the accessor and/or content player may be used to track demographic data such as accessor location, access time, access frequency, etc.

In preferred embodiments of the invention content players 103 are user-personal interfaces, installed on user machines. Such players give users complete freedom to configure the player and player display qualities. Preferably such players comprise the following features:

Virtual Desktops (like X-Windows or Citrix or Windows 2000 Professional)

Skinable Components (background, control bar, Internet radio station controls, etc.)

Common GUI features such as:

Snap to grid

Click and Drag layout

Save positioning

Close/minimize

Viewer(s) for reviewing content of data structure library(s) 104, and directors of data structures available in such library(s) and of various library(s) 104 operated by different service providers

Internet access to control manager(s) 101, content editors 102, and data structure library(s) 104

Tools for assisting commercial use of protected data structures according to the invention in conjunction with operator(s) of control manager(s) 101, content editors 102, and data structure library(s) 104

Directory (complete listing of data structures and groupings of data structures, plus traffic and revenue charts, demographics, and other activity related information).

In at least one business model for implementation of systems and methods according to the invention, content players 103 are distributed free of charge to accessors 111, optionally with charges for enhancements or upgrades. Distribution of content players will utilize various novel and conventional marketing techniques.

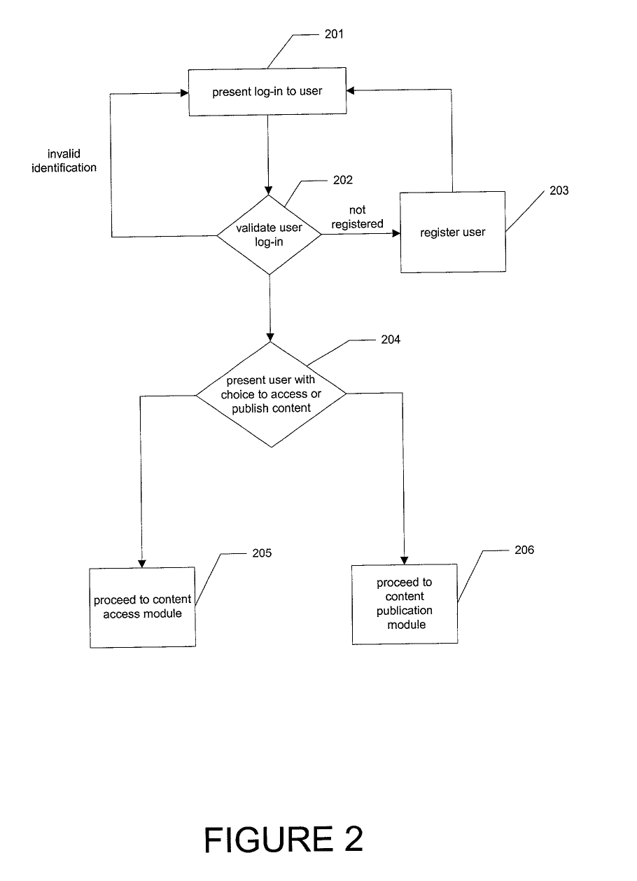

FIG. 2 is a flow diagram presenting a method for a user to select whether to publish or purchase electronic information.

Content player 103 presents the user with a login screen wherein the user is required to input a username and password, or other unique identifying information, step 201. The user also is presented with an input option indicating that they are a new user to the system and need to register to set up a user account and obtain a username and password or other unique identifying information. The player then proceeds to validate the unique identifying information input by the user, step 202. Validation is performed by querying control data base 107 which contains control information used to regulate access to protected content.

If the user input is invalid, then the user is returned to the login screen. An example of invalid user input is an invalid username or password.

If the user indicates that they need to register to set up a user account, then the user is presented with a registration form screen or other device with which to input identifying criteria used to establish the user account, step 203. Once the user completes the registration information, the user information is stored in control data base 107 and the user is returned to the login screen.

If the user login input is valid, then the user is presented with a choice to access content or to publish content, step 204. In some embodiments of the invention, the user may also be offered the choice only to access content or only to publish content.

If the user choice is to access content, then the content access module is initiated, step 205. If the user choice is to publish content, then the content publication module is initiated, step 206.

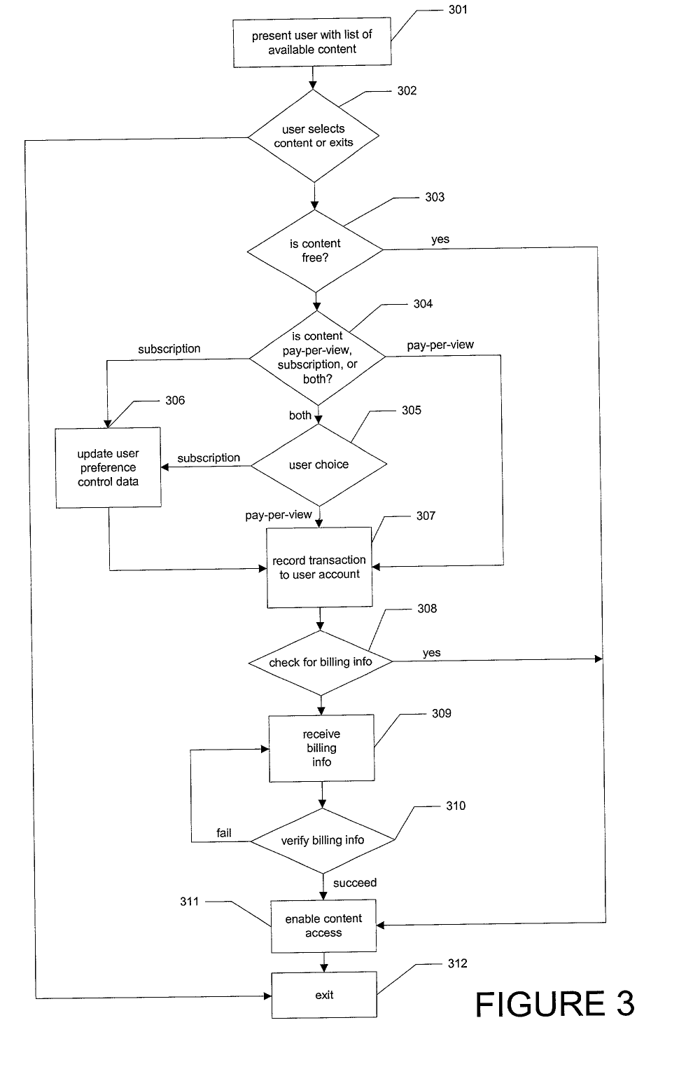

FIG. 3 is a flow diagram presenting a method for a user to purchase electronic information.

Content player 103 presents user 111 with the results of a query to control manager 101 for a list of content accessible to content player 103. Control manager 101 generates this list by querying data structure library 104. In some embodiments of the invention, content player 103 queries data structure library 104 directly and bypasses control manager 101.

User 111 then selects from the presented list of content accessible to content player 103 or chooses to exit the subroutine, step 302. If user 111 selects content from the presented list of content accessible to content player 103, then content player 103 queries control manager 101 whether the selected content is free or not, step 303. Control manager 101 queries control data base 107 regarding the status of the selected content and returns the query result to content player 103.

If the selected content is free and does not require payment to decrypt, then control manager 101 authorizes content player 103 to decrypt and access the selected content, step 311.

If the selected content requires payment, then control manager 101 indicates to content player 103 whether the payment method required is in the form of a subscription, in the form of a single payment such as a pay-per-view, or if user 111 is allowed to choose between either a subscription payment or a single payment such as a pay-per-view, step 304.

If user 111 is allowed to choose between either a subscription payment or a single payment such as a pay per view, then content player 103 presents user with a form screen or other device which user 111 can use to input their choice of payment method, step 305.

If the payment method for the selected content specified by the control manager in step 304 is a subscription payment or if user 111 selects a subscription payment in step 305, then the control manager 101 updates control data in control data base 107 associating user 111 with a subscription to the selected content, step 306.

At this point, or if the payment method for the selected content specified by the control manager in step 304 is a subscription payment or if user 111 selects a single payment method such as a pay-per-view payment in step 305, the control manager attempts to record the transaction to purchase the selected content to user 111 account control information contained in control data base 107, step 307.

To record the transaction to user 111 account control information contained in control data base 107, control manager 101 queries control data base 107 whether user 111 account control information is already associated with billing information for user 111, step 308. For example, user 111 may have already input credit card information for use in purchasing selected content. If user 111 account control information is already associated with billing information for user 111, then control manager 101 authorizes content player 103 to decrypt and access the selected content, step 311.

If user 111 account control information is not already associated with billing information for user 111, then control manager 101 queries user 111 to provide such billing information, step 309. Once user 111 provides such billing information to purchase content, the billing information is verified by control manager 101, step 310. For example, the billing manager may query the issuer of a supplied credit card whether sufficient funds exits for the purchase of the selected content. If control manager succeeds in verifying the billing information provided by user 111, then the billing information is associated with user account control data contained in control data base 107, and control manager 101 authorizes content player 103 to decrypt and access the selected content, step 311. Program control is then returned to content player 103 and the content access subroutine is exited, step 312.

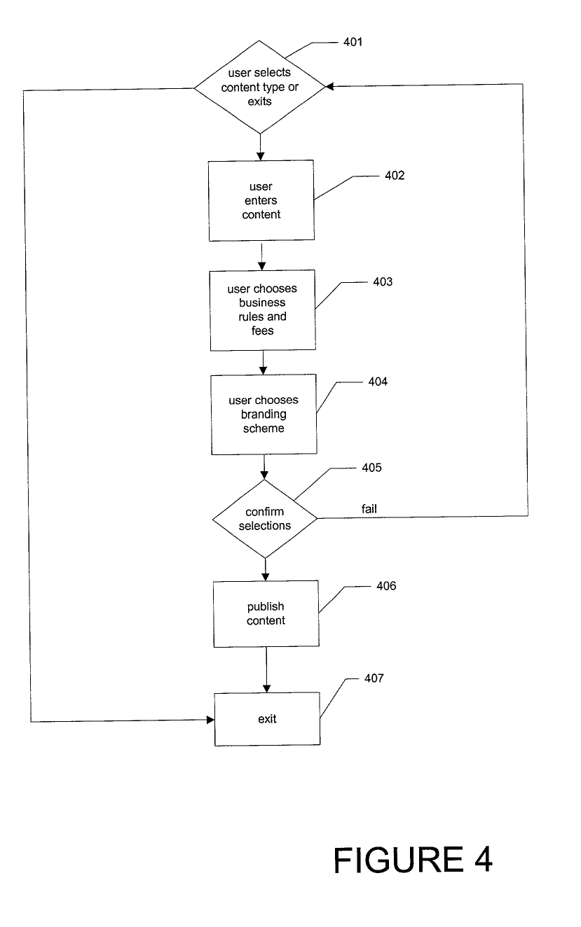

FIG. 4 is a flow diagram presenting a method for a user to publish electronic information.

Content editor 102 offers user 111 the choice to select a type of content to publish or to exit from the content publication subroutine, step 401. If user 111 indicates a choice to exit, then the content publication subroutine is exited, step 407. Otherwise, user 111 will indicate a file type or other identifying aspect of electronic information to be encrypted in a protected data structure. In some embodiments, user 111 may be presented by content editor 102 with a list of permissible content types obtained from control data base 107.

Once user 111 indicates a choice of content to be encrypted, then user 111 enters the content to be encrypted into content editor 102, step 204. Entering the content may comprise typing content directly into a form, selecting content from a list of computer files or software applications, or otherwise indicating to content editor 102 the electronic information to be encrypted in a protected data structure.

User 111 then selects any business rules or fees to associate with decryption of the electronic content to be encrypted, step 403. Examples of business rules are payment methods such as subscription or pay-per-view, total number of decryptions permitted, total number of uniquely identified content players 103 able to decrypt the electronic content, and other similar characteristics. User 111 may also indicate an precise fee required to be paid before decryption of the electronic content is authorized by control manager 101.

User 111 then optionally chooses a branding scheme to associate with the electronic content, step 404. Schemes may be obtained from data library 104 or alternatively specified by user 111 from another source.

User 111 is presented with a final confirmation option prior to publication of content, step 405. If user 111 indicates that they do not wish to publish the electronic content, then control is returned to step 401. Otherwise, the content is published and made available to other content players 103 and users 111. In one embodiment, publication is accomplished by adding the newly created content to the list of content available in data structure library 104 and storing content on storage devices 105 associated with data structure library 104.

The content publication subroutine then exits and control is returned to content player 103, step 407.

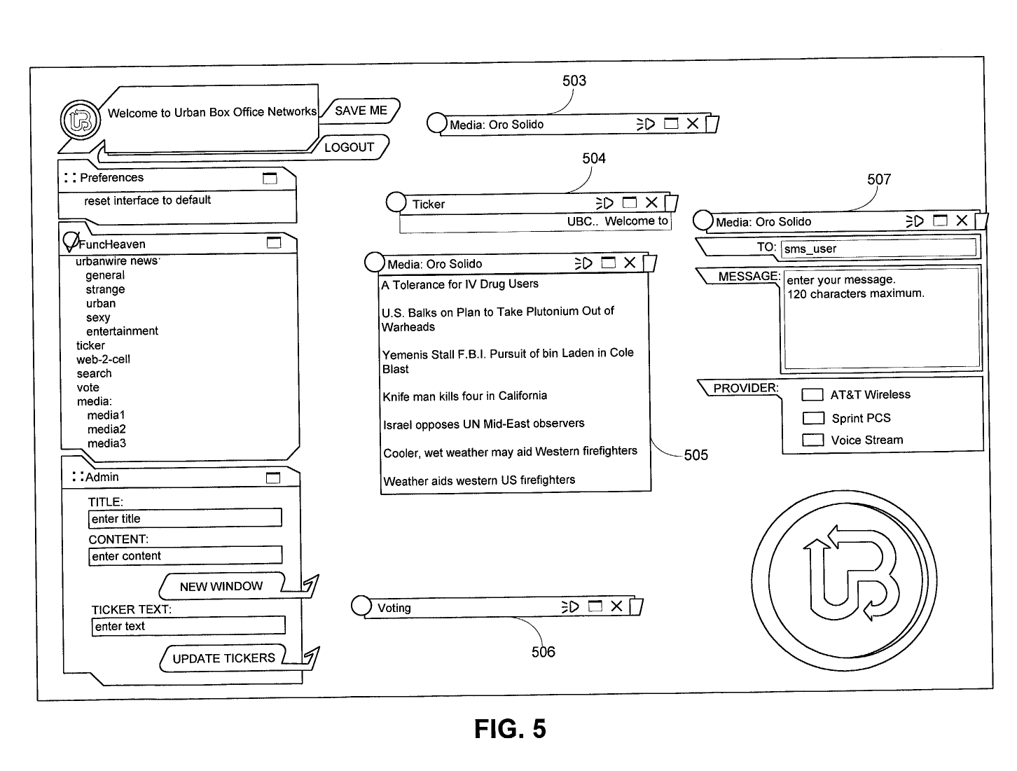

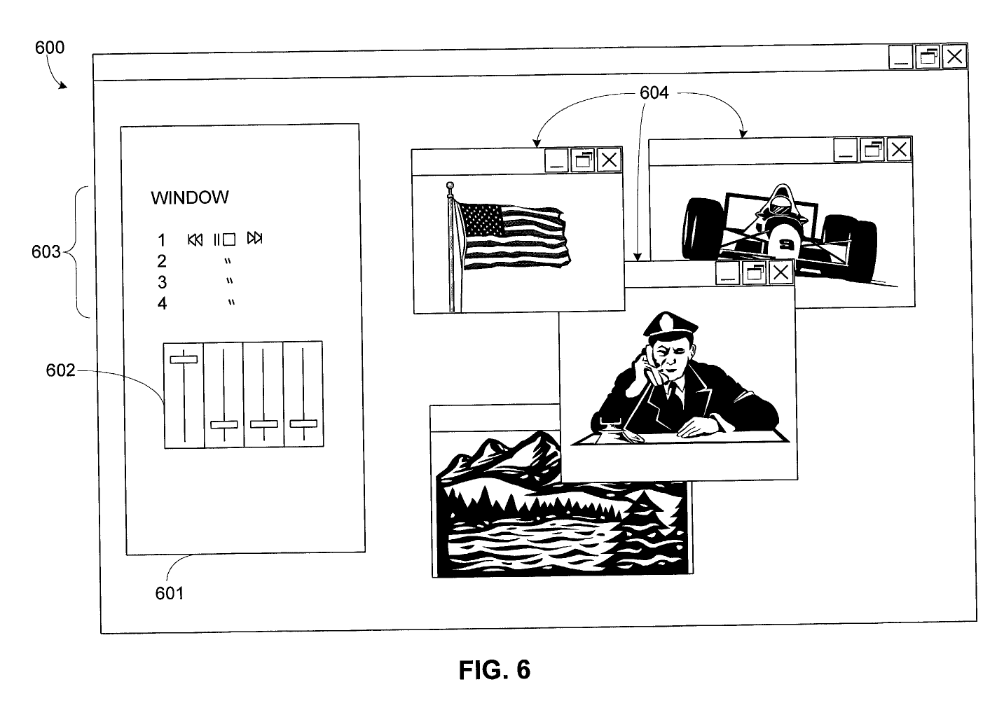

FIGS. 5 and 6 depict user interface screens for a content player according to the invention. FIG. 5 shows a start-up screen resulting from starting the player program. Field 501 provides browsing search/capability for the library database, entitled “funcHeaven,” and lists data structures accessible by the player and/or user for news, financial information, polling, and various media. Preferences field 502 enables a user interactively to modify the screen suit to his/her preferences selecting various selectable items by means of any suitable pointing device, such as mouse, trackball, or other pointer. Fields 503, 504, 505, and 506 comprise subwindows which are displaying some of the data structures listed in field 501. Field 507 provides an interactive user interface, based primarily on point and click techniques using a user interface tool such as a mouse or trackball, for sending and receiving messages, and organizing previously received messages.

FIG. 6 shows a user interface screen presented by a content player 103. Field 601 comprises controls 602, 603 for controlling playback and volume of presentation content of accessed data structures displayed in fields 604. Additional controls might include controls for controlling player appearance, content delivery preferences, content storage preferences, content layout and display preferences, and other similar user preferences relating to the creation, modification, maintenance, distribution, and presentation of electronic content.

Protected data structures according to the invention comprise presentation content, identification content, and preferably control content. The identification content of a given data structure is used to facilitate unique identification of the structure, and to protect copyright and ensure appropriate attribution for the structure's presentation content. Optionally the identification content comprises coding or information which, upon action by control manager 101 in the event of attempted tampering or unauthorized use or access, renders the presentation content inaccessible. The control content comprises creator/owner specified conditions or rules for access by users 111 and/or content players 103, and can include commercial propositions, licensing requirements, advertisements, etc. It is envisioned that individual data structures, or distinct copies thereof, will be used, as for example stored or syndicated, by multiple libraries 104. Viewing and syndication properties may be dynamically controlled by the data structure owner, and can be modified “on the fly.” For example, a media ownership company might publish a data structure comprising an animation featuring a popular animation character, and limit viewing access to a finite number of occurrences, thus making the data structure a rare and much sought-after product.

A protected data structure according to the invention may comprise control content supporting any of the following restrictions/attribute characteristics:

Pay-Per-View

Subscription

Sponsor/Advertiser supported

Free

Limited release

Distribution enabled

Syndication enabled

Rights Purchase enabled

License enabled

Brandable

Brand Protected (publishers brand remains attached throughout distribution)

Sample topics for presentation content comprise, for example:

News—containing live news feeds and created “on the fly”

Weather Maps—containing live weather maps feeds Gaming, including syndicated or multi-player games

Instant Messaging—sends messages to any instant messenger client from a user's own content player

Short Message Service (“SMS”) Messaging—sends messages to any SMS enabled cellular telephone from a user's own content player

Search—queries a database and displays the results within a protected data structure

Voting results—dynamically modified by embedded code to contain polling results from multiple accessors

Control Bar—controls the features of a site enabled by content within a protected data structure

Presentation content can comprise, for example, full frame movies, transactions, and animations. Content producer 110 can specify, for example, (as control content) rules for accessing the presentation content, such as how many viewings of graphical content are allowed, when and where the presentation content can be displayed, and the nature of the economic proposition (i.e.: is the content free-per-view, pay-per-view, advertiser/sponsor supported, subscription, etc). Content producer 110 also specifies which category of content they are producing.

In one business model, the creation of protected data structures is free. However, content producer/controllers are charged:

A set-up fee for maintaining an identified library 104 in a database operated in association with the content editor

A percentage of all revenue generated through access of the data structure. Percentages may vary, for example, depending upon satisfaction of specified revenue milestones.

In such a business model content producers are required to enabling software from the content editor server provider. Various packages tailored to different business needs of content producers may be offered, as for example:

A first package intended for individual users who want to create small sites at their own domains. This package affords user 111 the ability to publish content onto his/her site, but nowhere else. Sale or distribution of user's 111 content is brokered via data library 104. Package upgrades may be purchased for additional cost.

### BUSINESS MODEL EXAMPLE 1

A content producer produces webmations in his spare time. He wants to put them up on his website so that they can be seen by his friends, and hopes that a major distributor will pick them up and take over publication. He modifies his animations into protected data structures according to the invention, and deposits them in an animation area in a library 104 operated by service provider. To encourage users to view his animations, he specifies, by use of content editor 102, that the first 1000 accessings are to be free of charge, and that subsequent accessings will be charged at $1 per each. He agrees to pay X % of the gross revenue generated from accessings of his data structures to the library service provider. When his product proves successful, he undertakes to create further protected animation data structures, and agrees to pay the service provider a small advance against his future earnings. When his success grows still further, he ultimate purchases all rights to his data structures from the service provider sets up his own web site.

### BUSINESS MODEL EXAMPLE 2

A major content producer wants to generate revenue on the 4,000,000 pieces of content it owns by building a data library 104 to store its content and take advantage of distribution/syndication opportunities and copyright protection features of a system for controlling data distribution according to the investment. The content producer purchases its own library rights outright from the service provider.

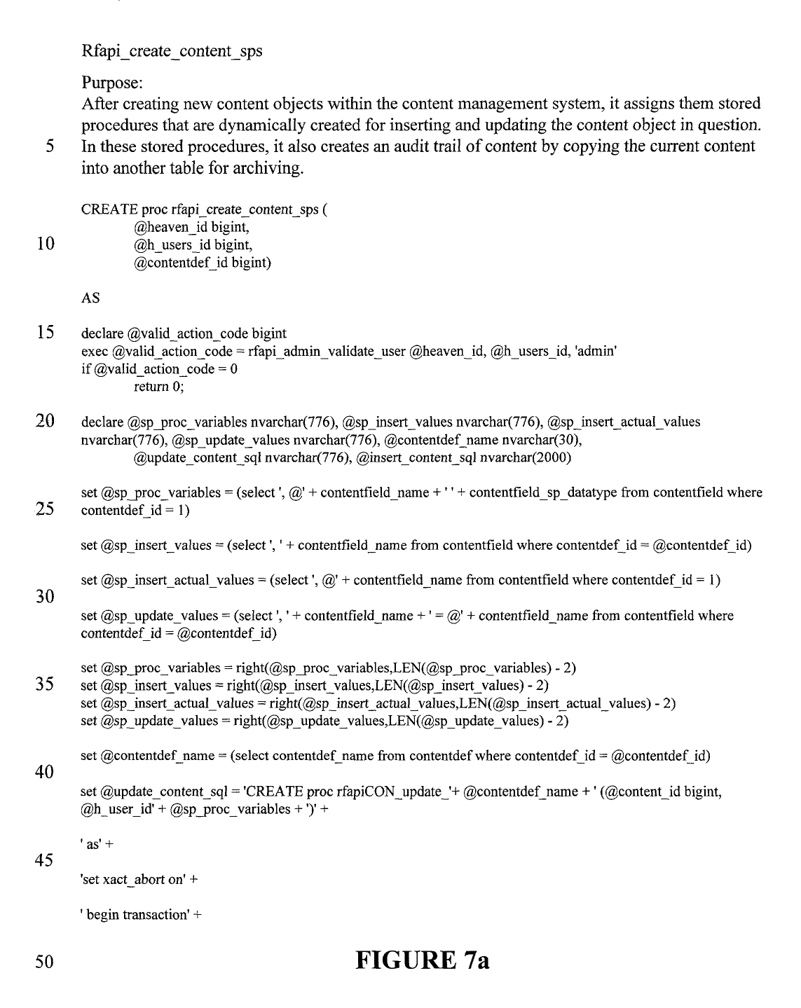

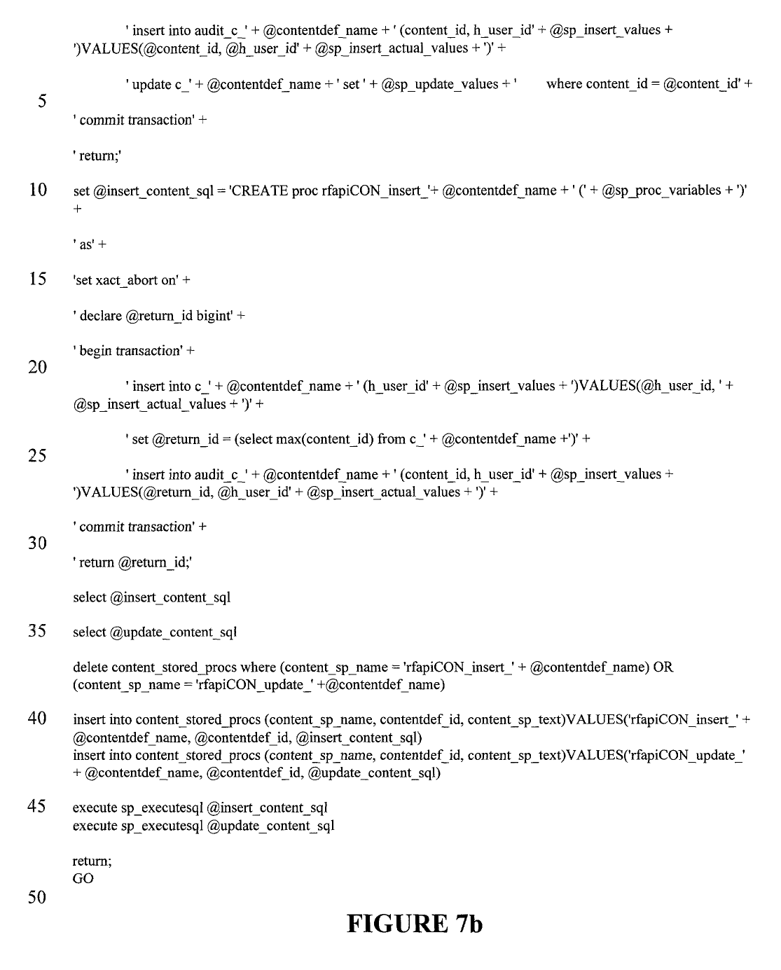

FIGS. 7a and 7b depict programming logic used in creating or modifying data structures by means of a content editor according to the invention. The content editor inserts within new or modified data structures objects for inserting and updating the content while creating an audit trail of content by copying the current content a separate table associated with the data record for archiving. In a preferred embodiment of the invention, this programming logic is stored in control database 107 as stored procedures.

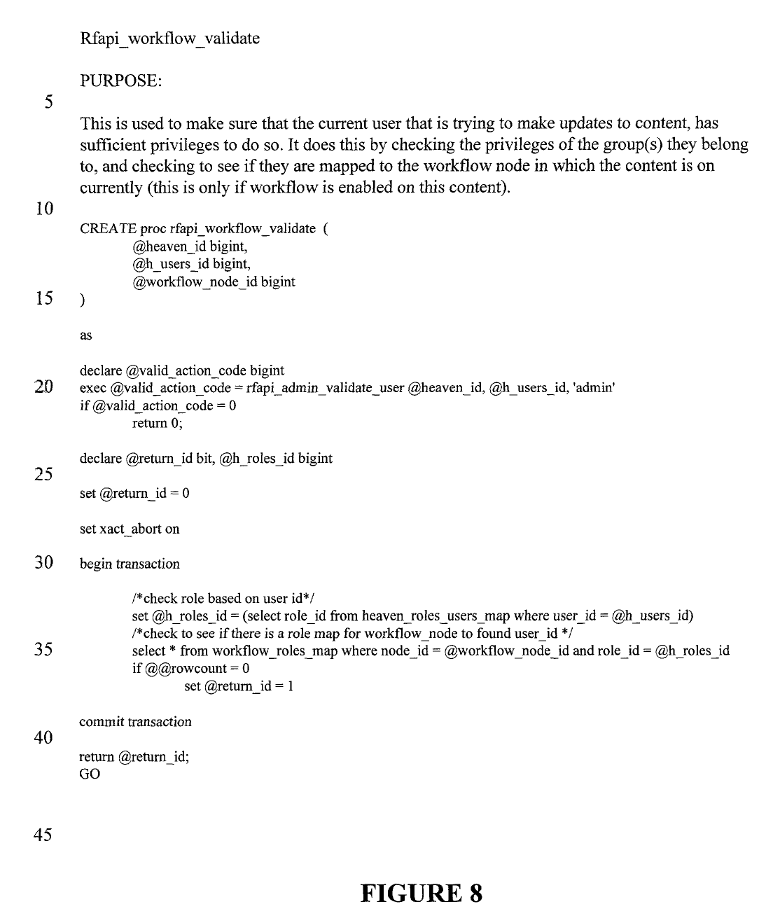

FIG. 8 depicts programming logic used in ensure that a content producer 111 attempting to modify a protected data record has sufficient privileges to do so. The code checks privileges of the group(s) the content producer belongs to in order to determine whether the content producer is mapped to a workflow node in which the content is on currently. The code assumes that workflow is enabled on the affected content. In a preferred embodiment of the invention, this programming logic is stored in control database 107 as stored procedures.

Data libraries 104 according to the invention may serve as online consumer or other-user destinations, as marketplaces where users, distributors and webcasters/broadcasters go to collect, trade and purchase protected data structures, and content creators, owners, and producers can:

1. showcase, sell, syndicate, distribute, license, even auction their content;

2. run promotions and advertise their protected data structures to stimulate distribution;

3. organize their data structure libraries into syndicatable or subscription tiers, suites, and collections.

A typical user experience at a data library according to the invention might be as follows:

A user, distributor, webcaster/broadcaster accesses the library. On the homepage user, distributor, webcaster/broadcaster notices a protectable data structure the user, distributor, webcaster/broadcaster wishes to acquire. The user, distributor, webcaster/broadcaster selects an “Add to Library” icon associated with the desired data structure and the data structure is added to user, distributor, webcaster/broadcaster's personal library (or in the case of a licensed distributor, added their own library 104).

The user, distributor, webcaster/broadcaster then adds several news and popular subscription movie/television./cable program data structures. As the user, distributor, webcaster, adds the protected data structures to his/her personal library, control manager 101 prompts him/her to comply with control criteria encoded within the data structures, such as subscriptions or other commercial agreements

Users can also add community, informational and transactional data structures their libraries for use on their sites, portals and networks. As with other protected data structures, these data structures are activated by connection to control manager 101, so that activity can be monitored any commercial conditions, such as revenue collections, can be consummated.

Software usable for modifying protected data structures may be sold commercially through control manager 101 and/or content editor 102, or through other suitable processes.

It is contemplated that, in some business models, operation of control manager 101 and data library 104 and/or content editor 103 will be controlled by separate business entities. For example, a Content Storage Provider (CSP), will operate library 104, including storage and delivery of the protected data structures. The operator of control manager 101 and/or content editor 102 will push protected data structures created in accordance with the invention to the to the CSP, who will store it in caches located around the world. When an accessor 111 requests a protected data structure, the request will be re-directed to the CSP server closest or otherwise most convenient to the to the user, leaving the control manager free to conduct the business of managing content. In exchange for providing the service the CSP becomes a revenge participant in the content it stores and delivers. A by-product of such an arrangement is that it enhances the perceived value of the control manger operator by making data storage sites 104 more accessible and significantly faster than the norm for conventional Internet or World Wide Web content providers.

Program structures for control manager 101, content editor(s) 102, content player(s) 103, and objects used for coordination or control of such program structures and/or library 104 may be written in any suitable machine readable code or language. For example, the RadFunc™ system created by Contemporary Holdings, Inc., of New York, N.Y., makes extensive use of proprietary combinations of HTML, MacroMedia Flash. The application server, which controls the control manager 101, content editor 102, and library 104 uses Macromedia Cold Fusion Server 5.0 as the application server, Macromedia Generator 2 for dynamic flash generation, and MS SQL2000 as the database technology. It is contemplated that following further development these functions will be migrated into an Oracle database. The bulk of the Application Programming Interface (API) resides within a system server database in the form of stored procedures or packages, enabling the system to be ported into any application server with database connectivity—for example, Microsoft's Active Server Pages, Macromedia Cold fusion, PHP, or Java Server Pages. Having major and frequently used functions, such as content retrieval, updating and inserting, as stored procedures on the database server for swift execution, reduces stress on site infrastructure and leaves the application server free to handle other tasks such as tracking activity of protected data structure, monitoring accessor habits and patterns, and handling control content such as business logic rules. The system uses Macromedia Generator to display real-time and offline presentation content within Flash, caching the content on the server instead of having to re-generate it every time a user requests it, therefore taking up less of valuable processing time.

Similarly, any hardware suitable for the purposes described will serve. One embodiment currently under development by the assignee of this application calls for the following minimum system requirements:

Control Manager:

(4) Load Balanced Web servers:

Pentium III 1 GHz w/256K Cache

512M SDRAM

(2) 9 GB Ultra3, 1 IN, 10K RPM, SCSI Hard Drive

PERC3-DCL RAID Card w/64 MB Cache 1 Int/1 Ext Channel

Dual On-Board NICS Only

24X IDE CD ROM

Windows 2000/IIS5 Web Server

Content Editor:

(3) Load Balanced Application servers:

Dual Pentium III 1 GHz w/256K Cache

1 GB SDRAM

(4) 9 GB Ultra3, 1 IN, 10K RPM, SCSI Hard Drive

PERC3-DCL RAID Card w/64 MB Cache 1 Int/1 Ext Channel

Dual On-Board NICS Only

24X IDE CD ROM

Windows 2000/IIS5 Web Server

Macromedia ColdFusion 5

Macromedia Jrun 3.1

Macromedia Generator 2-

Library:

(2) DataBase Servers:

Dual Pentium III 1 GHz w/256K Cache

2 GB SDRAM, 4 DIMMS

(2) 9 GB Ultra3, 1 IN, 10K RPM, SCSI Hard Drive

(7) 36 GB Ultra3, 1 IN, 10K RPM, SCSI Hard Drive

PERC3-DCL RAID Card w/64 MB Cache 1 Int/1 Ext Channel

Dual On-Board NICS Only

24X IDE CD ROM

Windows 2000

Oracle Database 8i

Auxiliary Server (email, Webtrends traffic logging, administration):

Dual Pentium III 1 GHz w/256K Cache

512 MB SDRAM, 4 DIMMS

(6) 36 GB Ultra3, 1 IN, 10K RPM, SCSI Hard Drive

PERC3-DCL RAID Card w/64 MB Cache 1 Int/1 Ext Channel

Dual On-Board NICS Only

24X IDE CD ROM

Windows 2000/IIS5 Web Server

WebTrends5

NTList Email Server

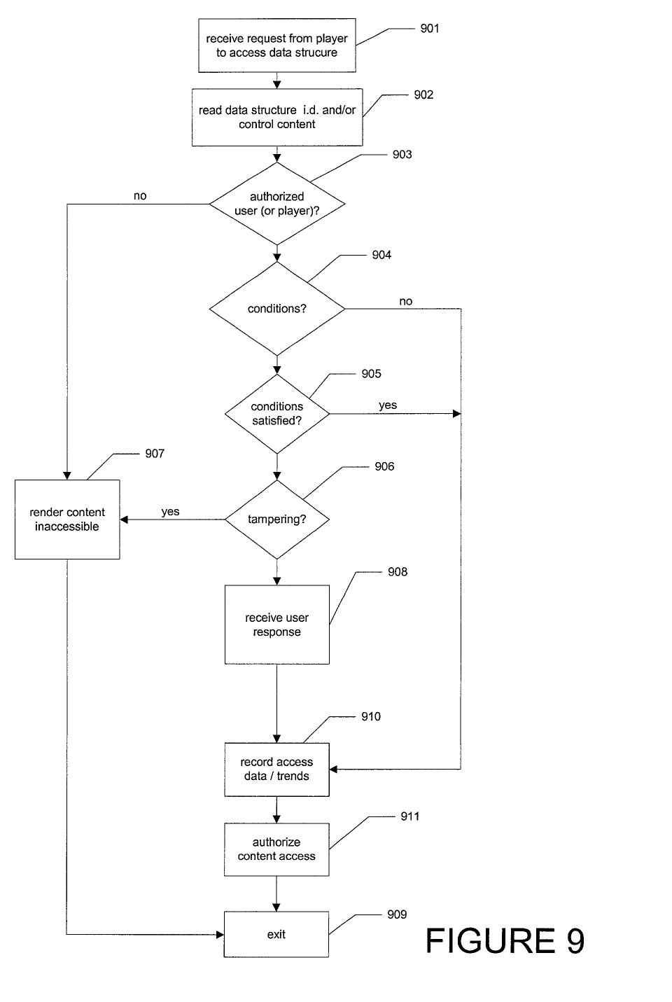

FIG. 9 is a flow diagram presenting a method to present protected electronic information to a user according to the invention.

A request is received from user 111 of uniquely identified content player 103 to decode encrypted electronic information contained in a data structure, step 901. The electronic information may, for example, comprise multimedia data or a software application.

Control manager 101 reads identification and/or control data associated with the protected data structure, step 902. This identification and/or control data is then used to determine whether to authorize content player 103 to decode the electronic information, step 903. For example, control data base 107 may be queried to ascertain whether user 111 has permission to access the uniquely identified data structure. If user 111 is not authorized, then control manager 101 renders the electronic content inaccessible and exits the subroutine returning control to content player 103, step 907.

If user 111 has permission to access the uniquely identified data structure, then control manager 101 further determines whether any conditions must be satisfied before decryption of the electronic information is authorized, step 904. Examples of conditions that must be satisfied are acceptance of a sales proposition, acceptance of a licensing proposition, providing certain requested information such as demographic information, whether the electronic information has been accessed more than a given number of times or by a given number of specific players, or other such conditional criteria.

If there are no conditions to satisfy, access trends are recorded such as a number of times the electronic information contained in the at least one protected data structure has been decrypted by one or more content players 103; an identity of a network node originating the request by the one or more content players 103 that decrypted the encrypted electronic information contained in the at least one protected data structure; information identifying one or more content players 103 that decrypted the encrypted electronic information contained in the at least one protected data structure; a time at which one or more content players 103 decrypted the encrypted electronic information contained in the at least one protected data structure; and a number of times communication of acceptance of a proposition relating to the decrypting of the encrypted electronic information contained in the at least one protected data structure has been communicated, step 910. Content player 103 is then authorized to decrypt the electronic information and the subroutine exits returning control to the content player, step 911.

Control manager 101 then determines whether any remaining conditions arc satisfied, step 905. In one embodiment, control manager 101 may query control data base 107 to ascertain whether user 111 has satisfied conditions to access the protected electronic information. If there are conditions that are satisfied, access trends are recorded such as a number of times the electronic information contained in the at least one protected data structure has been decrypted by one or more content players 103; an identity of a network node originating the request by the one or more content players 103 that decrypted the encrypted electronic information contained in the at least one protected data structure; information identifying one or more content players 103 that decrypted the encrypted electronic information contained in the at least one protected data structure; a time at which one or more content players 103 decrypted the encrypted electronic information contained in the at least one protected data structure; and a number of times communication of acceptance of a proposition relating to the decrypting of the encrypted electronic information contained in the at least one protected data structure has been communicated, step 910. Content player 103 is then authorized to decrypt the electronic information and the subroutine exits returning control to the content player, step 911.

If the conditions have not been satisfied, control manager 101 determines whether user 111 has committed an unauthorized attempt to access, decode, decrypt, or display the encrypted electronic information, step 906. If control manager 101 determines that user 111 has committed an unauthorized attempt to access, decode, decrypt, or display the encrypted electronic information, then control manager 101 renders the electronic content inaccessible and exits the subroutine returning control to content player 103, step 907. Examples of rendering the electronic content inaccessible are deleting the electronic content or corrupting the data of the electronic content.

If user 111 has not committed an unauthorized attempt to access, decode, decrypt, or display the encrypted electronic information, then control manager 103, if possible, provides user with an opportunity to satisfy the conditions prohibiting decryption of the electronic information, step 908. User 111 might, for example, be allowed to pay a fee to decrypt the electronic information.

If it is not possible for user 111 to satisfy the conditions or if user 111 declines the opportunity to satisfy the conditions prohibiting decryption of the electronic information, then control manager 101 exits the subroutine returning control to content player 103, step 909.

If user 111 accepts the opportunity to satisfy the conditions prohibiting decryption of the electronic information, access trends are recorded such as a number of times the electronic information contained in the at least one protected data structure has been decrypted by one or more content players 103; an identity of a network node originating the request by the one or more content players 103 that decrypted the encrypted electronic information contained in the at least one protected data structure; information identifying one or more content players 103 that decrypted the encrypted electronic information contained in the at least one protected data structure; a time at which one or more content players 103 decrypted the encrypted electronic information contained in the at least one protected data structure; and a number of times communication of acceptance of a proposition relating to the decrypting of the encrypted electronic information contained in the at least one protected data structure has been communicated, step 910. Content player 103 is then authorized to decrypt the electronic information and the subroutine exits returning control to the content player, step 909.

It will be understood that the systems and software referenced herein include;, either explicitly or implicitly, software implemented on computers or other appropriate hardware, including such other intelligent data processing devices having a processor, data storage means, and the ability to support an operating system, with or without user interfaces, for example, file servers, as may be useful in achieving the objectives of this invention.

Software components and applications embodying the invention can be distributed in electronic bit storage on magnetic, optical, bubble, or other media, and optionally in transportable form to be interactive with an electronic reading device, for example, on computer or optical diskettes, or may be distributed over wired or wireless networks for storage by the recipient on such media.

Preferred embodiments of the invention provide such media-stored software in a commercial package accompanied by instructions in a printed form, for deployment of the software on particular embodiments of a general purpose computer to cause same to operate as a special purpose computer, in accordance with the objectives of the invention. License agreements and registration as a means for updating may also be included. Alternatively, the instructions may also be provided as data files.

It will further be appreciated that such media-stored software constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of a certain set of configuration parameters. When so configured, the special-purpose computer device has an enhanced value, especially to the professional users for whom it may be intended.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A control manager for controlling access to encrypted electronic information contained in a protected data structure, the control manager adapted to:
receive a request from a uniquely-identified content player to decode encrypted electronic information contained in a protected data structure;
read identification content associated with the protected data structure; and to
determine whether to authorize the uniquely-identified content player to decrypt the encrypted electronic information.

2. The control manager of claim 1, further adapted to read control content contained in the at least one protected data structure.

3. The control manager of claim 2, further adapted to determine whether any conditions specified by the control content have been satisfied.

4. The control manager of claim 3, wherein the determination whether to authorize the content player to decrypt the encrypted electronic information is conditioned upon satisfaction of conditions specified by the control content.

5. The control manager of claim 3, wherein a condition specified by the control content is acceptance of a proposition.

6. The control manager of claim 5, wherein the proposition is a sales proposition.

7. The control manager of claim 5, wherein the proposition is a licensing proposition.

8. The control manager of claim 5, wherein the proposition comprises a request for information.

9. The control manager of claim 8, wherein the information comprises demographic information.

10. The control manager of claim 3, wherein a condition specified by the control content comprises a limit on the number of times the encrypted electronic information may be decrypted.

11. The control manager of claim 10, wherein the limit pertains to decryption by a specific uniquely-identified content player.

12. The control manager of claim 1, wherein a user of the at least one content player supplies the information which uniquely identifies the content player.

13. The control manager of claim 1, wherein the determination whether to authorize the content player to decrypt the electronic information is based upon data associated with at least one of the protected data structure, the content player, and a user of the content player.

14. The control manager of claim 1, wherein the encrypted electronic information contained in the at least one protected data structure comprises multimedia data.

15. The control manager of claim 1, wherein the encrypted electronic information contained in the at least one protected data structure comprises a software application.

16. The control manager of claim 1, wherein the encrypted electronic information comprises information identifying a creator of the protected data structure.

17. The control manager of claim 1, further adapted to render the protected data structure inaccessible upon an unauthorized attempt to access, decode, decrypt, or display the encrypted electronic information.

18. The control manager of claim 1, further adapted to delete the protected data structure upon an unauthorized attempt to access, decode, decrypt, or display the encrypted electronic information.

19. The control manager of claim 1, further adapted to authorize modification of the at least one protected data structure.

20. The control manager of claim 1, further adapted to authorize modification of control data associated with the at least one protected data structure.

21. The control manager of claim 1, further adapted to authorize modification of encrypted electronic information contained in the at least one protected data structure.

22. The control manager of claim 1, adapted to receive the request to decrypt the encrypted electronic information contained in the at least one data structure via a computer network.

23. The control manager of claim 1, further adapted to record at least one of: a number of times the electronic information contained in the at least one protected data structure has been decrypted by one or more content players; an identity of a network node originating the request by the one or more content players that decrypted the encrypted electronic information contained in the at least one protected data structure; information identifying one or more content players that decrypted the encrypted electronic information contained in the at least one protected data structure; a time at which one or more content players decrypted the encrypted electronic information contained in the at least one protected data structure; and a number of times communication of acceptance of a proposition relating to the decrypting of the encrypted electronic information contained in the at least one protected data structure has been communicated.

24. The control manager of claim 1, further adapted to access memory comprising a listing of all protected data structures that at least one specific content player associated with unique identification data is authorized to access.

25. The control manager of claim 1, further adapted to access memory comprising a listing of all protected data for which the content manager can authorize decryption.

26. A uniquely-identifiable content player for accessing and presenting encrypted electronic information contained in at least one protected data structure, the content player adapted to:
read identification content associated with a protected data structure containing encrypted electronic information;
communicate a request comprising the identification content to a control manager for authorization to decrypt the encrypted electronic information; and to
upon authorization from the control manager, decrypt the encrypted electronic information.

27. The content player of claim 26, further adapted to accept from a user and communicate to the content manager a request to decrypt the encrypted electronic information.

28. The content player of claim 26, wherein a display created by the content player is customizable by the user of the content player.

29. The content player of claim 26, wherein the content player is capable of simultaneously displaying electronic information contained in a plurality of protected data structures.

30. The content player of claim 26, wherein the content player is adapted to display electronic information contained in the least one protected data structure according configuration settings specified by the control manager.

31. The content player of claim 26, wherein the content player is adapted to display decrypted electronic information data in a graphical window.

32. The content player of claim 31, wherein the appearance of the graphical window can be configured in the manner of a window on the desktop of a Microsoft Windows 2000 Professional operating system.

33. The content player of claim 31, wherein the graphical window can be configured by at least one of the following group of actions: snapping to grid, clicking and dragging, resizing, saving positioning, opening, closing, maximizing, and minimizing.

34. The content player of claim 26, further adapted to display control information associated with the at least one data structure prior to decrypting the encrypted electronic information contained in the at least one data structure.

35. The content player of claim 26, wherein the encrypted electronic information comprises multimedia data.

36. The content player of claim 26, further adapted to display a list of all protected data structures containing encrypted electronic information for which the control manager has previously authorized decryption.

37. The content player of claim 26, further adapted to display a list of all protected data structures containing encrypted electronic information for which the control manager can authorize decryption.

38. The content player of claim 26, wherein the encrypted electronic information comprises a software application.

39. A data structure for storing encrypted electronic information, the data structure comprising:
identification content uniquely identifying the protected data structure;
encrypted electronic information; and
control content for use in determining whether decryption of said encrypted electronic information is authorized.

40. The data structure of claim 39, wherein the encrypted electronic information comprises multimedia data.

41. The data structure of claim 39, wherein the encrypted electronic information comprises a software application.

42. A content editor for creating and modifying protected data structures containing encrypted electronic information, the content editor adapted to:
receive from a content producer electronic information, the information optionally to be encrypted, to incorporated into a protected data structure;
associate with the encrypted information a control content for use in determining authorization access to the encrypted information; and to
associate with the protected data structure identification data capable of uniquely identifying said protected data structure.

43. The content editor of claim 42, further adapted to modify the encrypted electronic information incorporated into the protected data structure.

44. The content editor of claim 42, further adapted to modify the identification data associated with the protected data structure upon command by an authorized content producer.

45. The content editor of claim 42, further adapted to modify the control content incorporated into the protected data structure upon command by an authorized content producer.

46. The content editor of claim 42, further adapted for storing the protected data structure for access by content players.

47. The content editor of claim 42, wherein the encrypted electronic information contained in the protected data structure comprises multimedia data.

48. The content editor of claim 42, wherein the encrypted electronic information contained in the protected data structure comprises a software application.

49. A method for controlling access to encrypted electronic information, the method comprising:
receiving a request from a uniquely-identified content player to decode encrypted electronic information contained in a protected data structure;
reading identification content associated with the protected data structure; and
determining whether to authorize the uniquely-identified content player to decrypt the encrypted electronic information.

50. The method of claim 49, wherein the data structure contains control content.

51. The method of claim 50, wherein the determination whether to authorize the content player to decrypt the encrypted electronic information is conditioned upon satisfaction of conditions specified by the control content.

52. The method of claim 50, wherein a condition specified by the control content is acceptance of a proposition.

53. The method of claim 52, wherein the proposition is a sales proposition.

54. The method of claim 52, wherein the proposition is a licensing proposition.

55. The method of claim 52, wherein the proposition comprises a request for information.

56. The method of claim 55, wherein the information comprises demographic information.

57. The method of claim 51, wherein a condition specified by the control content comprises a limit on the number of times the encrypted electronic information may be decrypted.

58. The method of claim 57, wherein the limit pertains to decryption by a specific uniquely-identified content player.

59. The method of claim 49, wherein a user of the at least one content player supplies the information which uniquely identifies the content player.

60. The method of claim 49, wherein the determination whether to authorize the content player to decrypt the electronic information is based upon data associated with at least one of the protected data structure, the content player, and a user of the content player.

61. The method of claim 49, wherein the encrypted electronic information contained in the at least one protected data structure comprises multimedia data.

62. The method of claim 49, wherein the encrypted electronic information contained in the at least one protected data structure comprises a software application.

63. The method of claim 49, wherein the encrypted electronic information comprises information identifying a creator of the protected data structure.

64. The method of claim 49, wherein the protected data structure is rendered inaccessible upon an unauthorized attempt to access, decode, decrypt, or display the encrypted electronic information.

65. The method of claim 49, wherein the protected data structure is deleted upon an unauthorized attempt to access, decode, decrypt, or display the encrypted electronic information.

66. The method of claim 49, wherein modification of the at least one protected data structure is allowed.

67. The method of claim 49, wherein modification of control data associated with the at least one protected data structure is allowed.

68. The method of claim 49, wherein modification of encrypted electronic information contained in the at least one protected data structure is allowed.

69. The method of claim 49, wherein the request to decrypt the encrypted electronic information contained in the at least one data structure is communicated via a computer network.

70. The method of claim 49, comprising recording at least one of: a number of times the electronic information contained in the at least one protected data structure has been decrypted by one or more content players; an identity of a network node originating the request by the one or more content players that decrypted the encrypted electronic information contained in the at least one protected data structure; information identifying one or more content players that decrypted the encrypted electronic information contained in the at least one protected data structure; a time at which one or more content players decrypted the encrypted electronic information contained in the at least one protected data structure; and a number of times communication of acceptance of a proposition relating to the decrypting of the encrypted electronic information contained in the at least one protected data structure has been communicated.

71. The method of claim 49, comprising accessing memory comprising a listing of all protected data structures that at least one specific content player associated with unique identification data is authorized to access.

72. The method of claim 71, wherein the at least one specific content player is capable of displaying the listing of all protected data structures containing encrypted electronic information that the at least one specific content player associated with unique identification data is authorized to access by the control manager to request decryption of the encrypted electronic information the protected data structures contain.

73. The method of claim 49, comprising accessing memory comprising a listing of all protected data structures for which the control manager can authorize decryption.

74. The method of claim 73, wherein the at least one content player is capable of displaying, the list of all protected data structures containing encrypted electronic information for which the content manager can authorize decryption.

75. The system containing at least two of a content editor, a protected data structure containing encrypted electronic information, a uniquely-identified content player, a group databank, and a control manager, adapted to:
incorporating encrypted electronic information into a protected data structure;
incorporating control content into the protected data structure; and to
associating with the protected data structure identification data capable of uniquely identifying said protected data structure.
receiving a request from a uniquely-identified content player to decode encrypted electronic information contained in the protected data structure;
reading identification content associated with the protected data structure; and
determining whether to authorize the uniquely-identified content player to decrypt the encrypted electronic information.
